(19) United States
(12) Patent Application Publication
(10) Pub. No.: US 2017/0053535 A1
(43) Pub. Date: Feb. 23, 2017

(54) AIRCRAFT THREE-DIMENSIONAL EXHIBITION SYSTEM AND AIRCRAFT THREE-DIMENSIONAL EXHIBITION CONTROLLING METHOD

(71) Applicant: CHUNGHWA PICTURE TUBES, LTD., Taoyuan City (TW)

(72) Inventors: Guan-Liang LEE, Taipei City (TW); Ru-Ji HSIEH, Taoyuan City (TW)

(21) Appl. No.: 15/001,256

(22) Filed: Jan. 20, 2016

(30) Foreign Application Priority Data
Aug. 20, 2015 (CN) 201510513063.1

(51) Int. Cl. G08G 5/00; G01S 15/08; G01S 15/93; G08G 5/04

(52) U.S. Cl. CPC G08G 5/0043; G08G 5/04; G01S 15/08; G01S 15/93

(57) ABSTRACT

An aircraft three-dimensional exhibition system and aircraft three-dimensional exhibition controlling method is provided. The aircraft three-dimensional exhibition system includes an aircraft controller and a plurality of aircrafts. Each of aircrafts includes an effect presenting device, a communication device and a dynamic reaction device. The effect presenting device provides an audio-visual effect. The communication device receives a flight control signal from the aircraft controller. The dynamic reaction device controls the aircraft to fly along a flight track according to the flight control signal. The aircrafts fly in formation according to a flight script to form a whole formation audio-visual effect by the audio-visual effects provided by each of the aircrafts, for displaying changing stereoscopic audio-visual effects.

### RELATED APPLICATIONS

This application claims priority to Chinese Application Serial Number 201510513063.1, filed Aug. 20, 2015, which is herein incorporated by reference.

### BACKGROUND

Field of Invention

The present invention relates to an aircraft three-dimensional exhibition system and an aircraft three-dimensional exhibition controlling method, and particularly to an aircraft three-dimensional exhibition system and an aircraft three-dimensional exhibition controlling method which use multiple aircrafts.

Description of Related Art

The traditional air display device includes a laser, a projection lamp, a projection machine, a firework and the like. The audio-visual effect of a concert generally presents an image in the air through a laser manner, wherein the laser beam generally has a single color and still needs a medium (e.g., using a smoke as a medium) in the air to project the laser light. Additionally, the manner of displaying an image in the air by using a projection lamp is disadvantageous in that it cannot dynamically change the image in real time, and also it needs a medium in the air for projection. The manner of projecting an image by means of a projection machine needs to place the projection machine at a position located relatively close to the wall surface or the water surface, so as to project the image, wherein the projection range is limited by the area size of the wall surface or the water surface. And, if an audience is at a place relatively far from the surface (e.g., a position distanced 1-2 kilometers away from the surface), it is hard for the audience to clearly see the projected image. If a firework is used as the manner of displaying the image in the air, it is easily to cause an environmental pollution and the firework has disadvantages of a high cost, a high risk and a fixed shape. If a firework with an effect of a specific shape is used, then a special manufacture process is needed, having the disadvantage of high manufacture cost.

In view of the above, it can be seen that the aforesaid existing manner obviously still has inconvenience and disadvantages, which needs to be further improved. Therefore it is a problem desired to be solved in the industry that how to achieve various displaying effects, recycling and reusing, and saving the cost at the same time during image displaying in the air.

### SUMMARY

In order to solve the aforementioned problem, an aspect of the present invention provides an aircraft three-dimensional exhibition system. The aircraft three-dimensional exhibition system includes an aircraft controller and multiple aircrafts. Each of the aircrafts includes an effect presenting device, a communication device and a dynamic reaction device. The effect presenting device is used for providing an audio-visual effect. The communication device is used for receiving a flight control signal from the aircraft controller. The dynamic reaction device is used for controlling the aircraft to fly along a flight track according to the flight control signal. The aircrafts fly in formation according to a flight script to form a whole formation audio-visual effect by the audio-visual effects provided by each of the aircrafts.

Another aspect of the present invention provides an aircraft three-dimensional exhibition controlling method for controlling multiple aircrafts each including an effect presenting device. The aircraft three-dimensional exhibition controlling method includes the following steps: establishing a flight script which includes a formation information and a flight track of the aircrafts in a flight period; generating a plurality of flight control signals according to the flight script and respectively sending these signals to the aircrafts, and controlling the aircrafts to fly in formation, while driving these effect presenting devices to form a whole formation audio-visual effect.

In view of the above, compared with the prior art, the technical solution of the present invention has obvious advantages and beneficial effects. Through the aforementioned technical solutions, a comparable technical progress can be achieved as well as the value of wide application in the industry. In the disclosure by controlling multiple aircrafts to fly in a formation manner and meanwhile driving the effect presenting devices, a whole formation audio-visual effect is formed.

### BRIEF DESCRIPTION OF THE DRAWINGS

FIG. 1 illustrates a block diagram of an aircraft three-dimensional exhibition system according to an embodiment of the present invention;

FIG. 2 illustrates a block diagram of an aircraft according to an embodiment of the present invention;

FIG. 3 illustrates a flow chart of an aircraft three-dimensional exhibition controlling method according to an embodiment of the present invention;

FIGS. 4A-4B illustrate top views of the formation manner of multiple aircrafts according to an embodiment of the present invention; and

FIG. 5 illustrates a schematic view of multiple aircrafts where an aircraft three-dimensional exhibition controlling method is applied according to an embodiment of the present invention.

### DETAILED DESCRIPTION

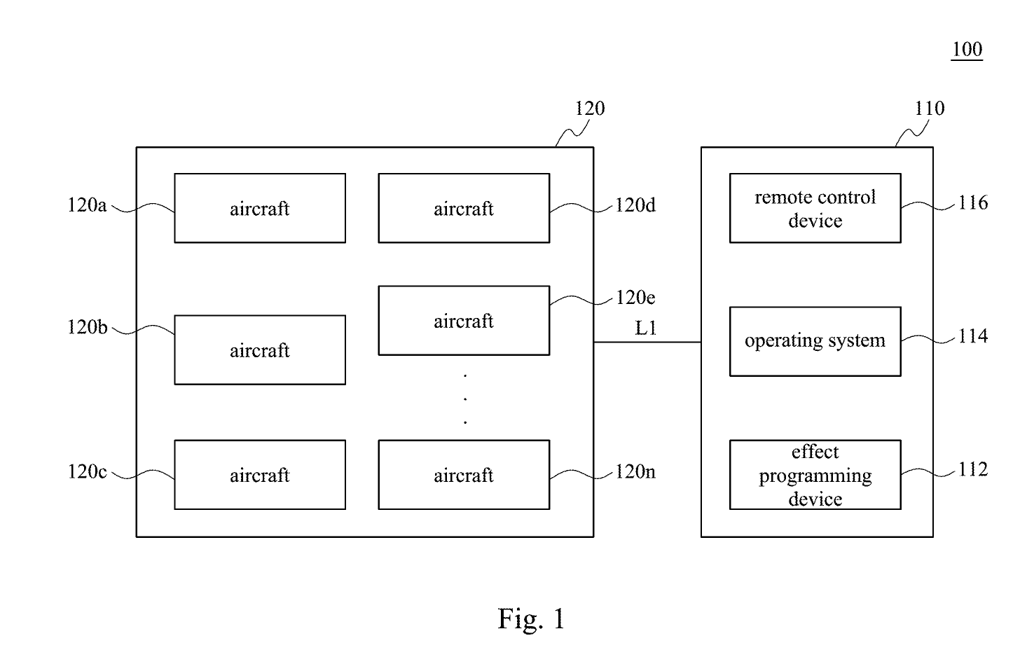

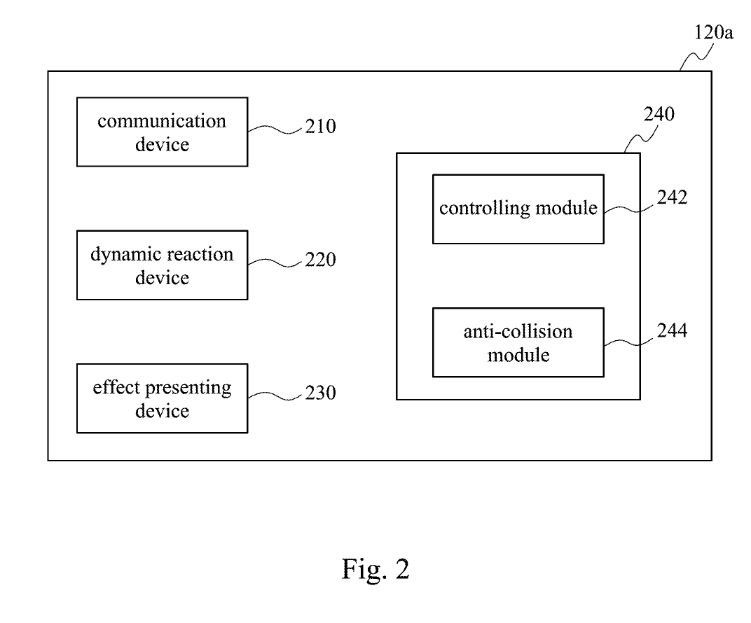

Referring to FIGS. 1-2, as shown in FIG. 1, an aircraft three-dimensional exhibition system 100 includes an aircraft controller 110 and multiple aircrafts 120a-120n. In an embodiment, the aircrafts 120a-120n are included in an aircraft formation 120, and may be unmanned aircrafts, e.g., a fixed-wing aircraft, a four-axis aircraft, an unfixed-wing aircraft, or other remotely-controlled aircrafts. In an embodiment, the aircraft controller 110 may be located in a ground control station.

Furthermore, as shown in FIG. 2, the aircraft 120a includes a communication device 210, a dynamic reaction device 220 and an effect presenting device 230. The communication device 210 is used for receiving a flight control signal from the aircraft controller 110. The communication device 210 is for example a 3G module or a wireless-network transmission module. The dynamic reaction device 220 is used for controlling the aircraft 120a to fly along a flight track according to the flight control signal. In an embodiment, the dynamic reaction device 220 can control the fixed wing, unfixed wing, four-axis rotation wing of a four-axis aircraft or other carriers of the aircraft 120a according to the flight control signal, so as to control at least one of the flying direction, speed or height of the aircraft 120a, such that the aircraft 120a flies along a flight track. The dynamic reaction device 220 is for example a microcontroller, a microprocessor, a digital signal processor, an application specific integrated circuit (ASIC) or a logic circuit. The effect presenting device 230 is used for providing an audio-visual effect. The effect presenting device 230 is for example at least one of a light-emitting device, a firework emitting device, a drikold emitting device or a smoke emitting device.

In an embodiment, the aircraft 120a further includes a processor unit 240 which is for example a central processor, a microprocessor or a logic circuit. The processor unit 240 includes a controlling module 242 and an anti-collision module 244. The anti-collision module 244 is used for calculating a relative distance between an aircraft 120a and another aircraft (e.g., the aircraft 120b), so as to determine whether a collision will occur between the aircraft 120a and another aircraft. The controlling module 242 and the anti-collision module 244 can be implemented independently or in combination through an integrated circuit such as a microcontroller, a microprocessor, a digital signal processor, an ASIC or a logic circuit.

Moreover, as will be understood by those of ordinary skills in the art, other aircrafts 120b-120n of FIG. 1 may have the same or similar elemental construction with the aircraft 120a of FIG. 2. That is, each of the aircraft 120a-120n includes an effect presenting device 230, a communication device 210 and a dynamic reaction device 220, and may further includes a controlling module 242 and an anti-collision module 244, wherein the function of these elements are similar to that of the aircraft 120a, and thus it will not be illustrated any further.

On the other hand, the aircraft controller 110 includes an effect programming device 112 and a remote control device 116. The effect programming device 112 is used for providing a flight script which includes formation information and a flight track of aircrafts 120a-120n in a flight period. The remote control device 116 is connected in communication with respective communication devices 210 of the aircrafts 120a-120n. The remote control device 116 sends the flight control signal respectively to the aircrafts 120a-120n according to the flight script, such that the aircrafts 120a-120n fly in formation according to the content of the flight script and meanwhile provides an audio-visual effect.

In an embodiment, the flight script provided by the effect programming device 112 can be adjusted according to the environment before the flight. For example, the flight script is adjusted by predicting factors such as the number of people on the ground, positions of other acting areas, a height of a ground building or a fixed substance. As such, the programming information and flight track can be defined more appropriately. Subsequently, the effect programming device 112 transfers the programmed flight script to a remote control device 116. After the flight script is received by the remote control device 116, the remote control device 116 generates the multiple flight control signals according to the flight script. And, the flight control signals are respectively sent to respective communication devices 210 of the aircrafts 120a-120n, such that the aircrafts 120a-120n fly in formation according to the content of the flight script and meanwhile an audio-visual effect is provided.

In an embodiment, the communication device 210 of the aircraft 120a only needs to receive information about a specific coordinate position required to be flown to in a specific time other than other information of other aircrafts 120b-120n. Since the flight script is arranged in advance by the effect programming device 112, the communication devices 210 of the aircrafts 120a-120n do not need to receive a large amount of information during the flight of the aircrafts 120a-120n.

In another embodiment, when one of the aircrafts 120a-120n is failed, the controlling module 242 located on the ground can automatically or manually transfers a control signal through a communication link L1 so as to remove the failed aircraft, and through another control signal remotely control another un-failed aircraft to serve as a replacement. In an embodiment, each of the aircrafts 120a-120n has identification information, wherein when the controlling module 242 transfers a control signal, a call is made according to the identification information corresponding to the failed aircraft, without transferring a large amount of data, such that the bandwidth between the controlling module 242 and the aircrafts 120a-120n is small and thus the architecture cost is reduced.

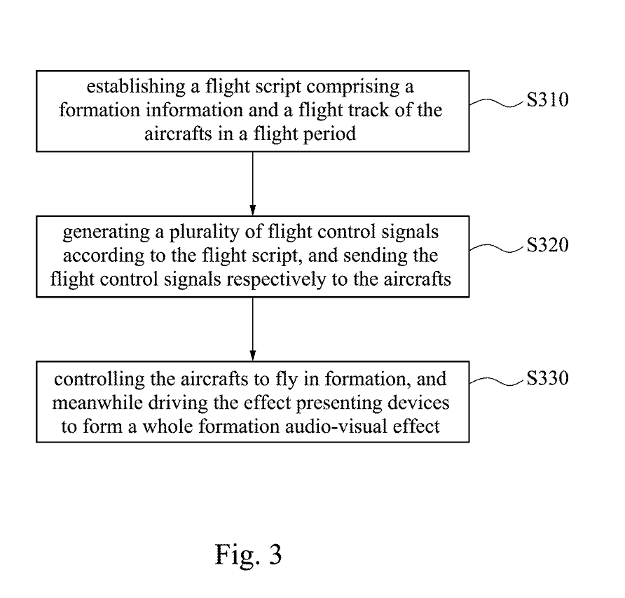

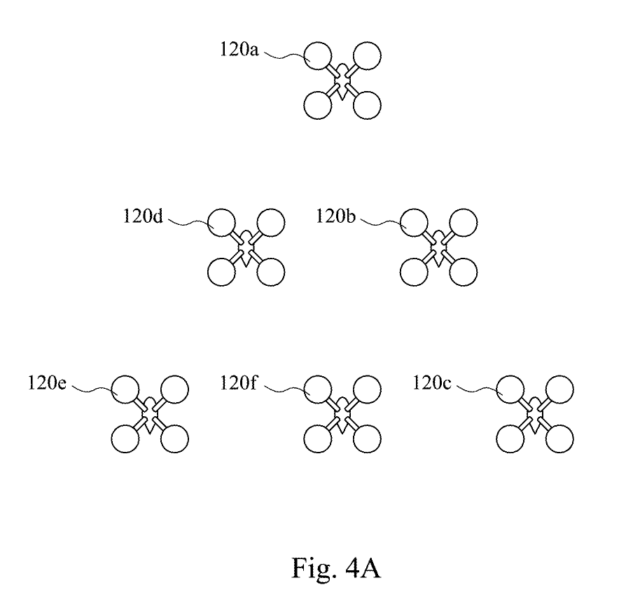

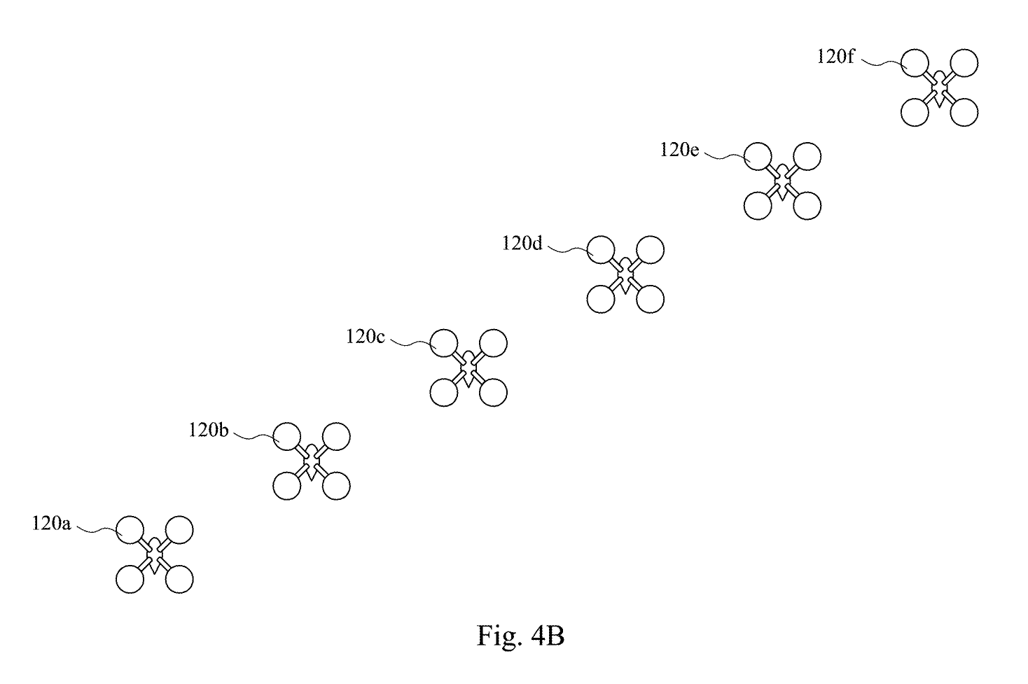

Hereafter the method of controlling the aircrafts 120a-120n to fly in formation according to the content of a flight script is further described in details. Reference is made to FIGS. 3-4. In step S310, the effect programming device 112 establishes a flight script which includes a formation information and a flight track of aircrafts 120a-120n in a flight period.

In an embodiment, as shown in FIG. 4A, the effect programming device 112 can in advance set up the arrangement manner of the aircrafts 120a-120n at various time points by setting formation information. For example, the formation information of the flight script established by the effect programming device 112 may be set as that the time is seven o'clock in the evening and the aircrafts 120a-120n are arranged in the air with a regular triangle shape. The content of the flight script includes predicted tracks of the aircrafts 120a-120n during the whole flight time, which may be represented as absolute position coordinates of the aircrafts 120a-120n varying over time, or as relative position coordinates of the aircrafts 120a-120n varying over time (or relative distance, or relative vector relationship). For example, as shown in FIG. 4A, at seven o'clock in the evening, the aircraft 120d is set as should be located at the bottom left side of the aircraft 120a and the top right side of the aircraft 120e, and as shown in FIG. 4B, at seven o'clock in the evening, the aircraft 120d is set as should move to the top right side of the aircraft 120c and the bottom left side of the aircraft 120e.

In another embodiment, the effect programming device 112 can set the flight tracks respectively for the aircrafts 120a-120n by using the identification information of respective aircrafts 120a-120n. For example, the effect programming device 112 can set the flight script as that the aircraft 120e of FIG. 4A flies towards a right-front direction of itself at a time near seven ten o'clock in the evening, such that the aircraft 120e is kept at a specific coordinate position as shown in FIG. 4B at the time of seven ten o'clock in the evening. In this way, the flight tracks of respective aircrafts 120a-120n are set, such that at the time of seven ten o'clock in the evening in the air the aircrafts 120a-120n are arranged in a shape of an inclined line.

In an embodiment, the effect programming device 112 can further set the corresponding effects presented by the aircrafts 120a-120n at a specific time point or in a specific time period in the flight script in advance. For example, the effect programming device 112 can set in advance that the aircrafts 120a-120n emit a blue smoke during the changing process of the programmed formation pattern (e.g., flying from the arranged position of FIG. 4A to the arranged position of FIG. 4B). Subsequently, the effect programming device 112 can further in advance set the flight script as that after the aircrafts 120a-120n respectively fly to specific coordinate positions (e.g., arranged at the programmed positions as shown in FIG. 4B) at the time of seven ten o'clock in the evening, the aircrafts 120a-120n activate respective light-emitting devices (e.g., a LED device) thereof simultaneously.

In step S320, the remote control device 116 generates a plurality of flight control signals according to the flight script and sends the flight control signals respectively to the aircrafts 120a-120n.

In an embodiment, after a flight script is established by the effect programming device 112, the effect programming device 112 transfers the flight script to the remote control device 116, and then the remote control device 116 generates multiple flight control signals according to the flight script, so as to control flight tracks of respective aircrafts 120a-120n, or the coordinate positions of respective aircrafts 120a-120n in the air at a specific time point and the effects presented thereby.

In an embodiment, the aircraft controller 110 may optionally include an operating system 114. After a flight script is established by the effect programming device 112, an automatic or manual operating manner is selected through the operating system 114 to transfer the flight script to the remote control device 116. Subsequently, the remote control device 116 generates multiple flight control signals according to the flight script and sends the flight control signals respectively to the aircrafts 120a-120n.

In step S330, the remote control device 116 controls these aircrafts 120a-120n to fly in formation, and meanwhile drives these effect presenting devices 230 to form a whole formation audio-visual effect.

For example, after generating multiple flight control signals according to the flight script, the remote control device 116 sends the flight control signals respectively to the aircrafts 120a-120n. These flight control signals control corresponding in-air positions to be flown to by the aircrafts 120a-120n at specific time points (as shown in FIGS. 4A-4B), such that at these specific time points the aircrafts 120a-120n are arranged in a pre-programmed formation pattern according to the flight script, and meanwhile the effect presenting device 230 is driven to form a whole formation audio-visual effect. The effect presenting device 230 may be at least one of a light-emitting device, a firework emitting device, a drikold emitting device or a smoke emitting device, or an audio device.

In an embodiment, each of the aircrafts 120a-120n may be a four-axis aircraft which can hover at a certain height, so that the aircrafts can respectively present effects at positions of certain heights. For example, in FIG. 4A at a specific time point, the aircrafts 120a, 120c and 120e hover at a height of 30 meters from the ground and emit a smoke while the aircrafts 120b, 120d and 120f hover at a height of 15 meters from the ground and twinkle with light sources of different colors, so that various visual effects can be generated.

In another embodiment, the remote control device 116 controls the aircrafts 120a-120n to fly in formation, and meanwhile drives the effect presenting devices 230 such that the effect presenting devices 230 are driven during the formation flight of the aircrafts 120a-120n. For example, while the aircrafts 120a-120n are arranged in the formation pattern as shown in FIG. 4A, the effect presenting devices 230 of the aircrafts 120a-120n respectively emit drikold and play music; during the process that the aircrafts 120a-120n change from the formation pattern of FIG. 4A to the formation pattern of FIG. 4B, respective effect presenting devices 230 of the aircrafts 120a-120n drive light-emitting devices with different colors (for example, the aircraft 120a drives a light-emitting device to emit a red LED light, and the aircraft 120b drives a light-emitting device to emit a green LED light); subsequently while the aircrafts 120a-120n are arranged in the formation pattern as shown in FIG. 4B, respective effect presenting devices 230 of the aircrafts 120a-120n emit fireworks so as to form a whole formation audio-visual effect.

On the other hand, each of the aircrafts 120a-120n may further include an anti-collision module 244 for calculating a relative distance between the aircraft (e.g., the aircraft 120a) to which the anti-collision module 244 is belonged and another aircraft (e.g., the aircraft 120b), so as to determine whether a collision will occur between the aircraft to which the anti-collision module 244 is belonged and another aircraft, thereby avoiding the collision of the aircrafts 120a-120n caused by path intercrossing. Hereafter, the anti-collision method of the aircraft three-dimensional exhibition system 100 is described in details below.

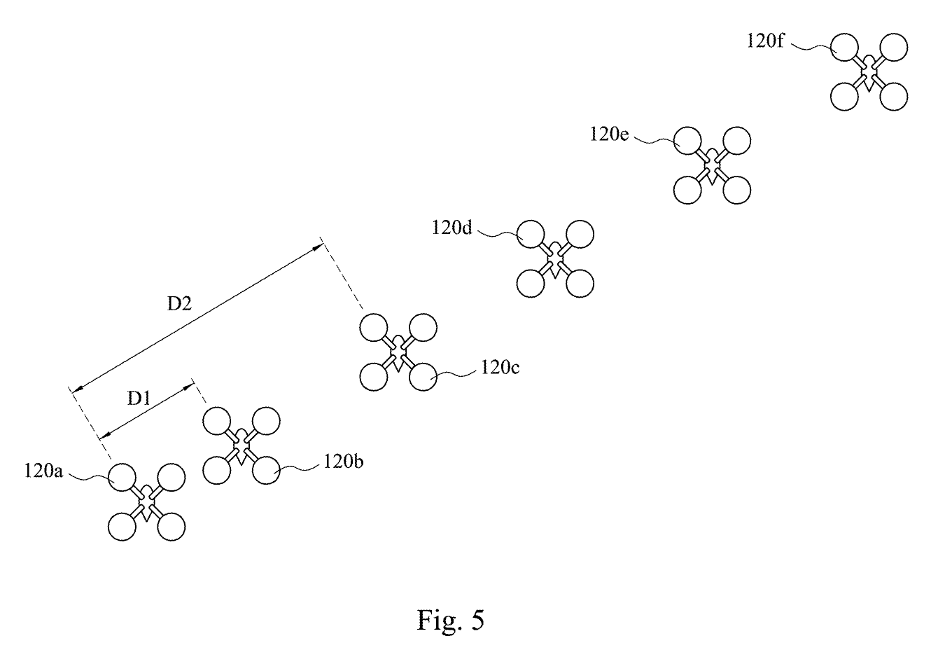

Referring to FIG. 5, as shown in FIG. 5, in an embodiment the aforementioned step S330 of controlling the aircrafts 120a-120n to fly in formation may further include monitoring a relative distance D1 between an aircraft 120a and another aircraft 120b in real time, wherein when the relative distance D1 between the aircraft 120a and the aircraft 120b at a specific time is smaller than a threshold value (e.g., 1 meter), it represents that the relative distance D1 between the aircraft 120a and the aircraft 120b is too small and a collision may be caused. Accordingly, the aircraft 120a adjusts the flying state thereof.

In an embodiment, when it is determined that a collision will occur between the aircraft 120a to which the anti-collision module 244 is belonged and the aircraft 120b, the aircraft 120a may adjust the flying height, speed or position thereof to avoid the collision with the aircraft 120b.

In another embodiment, the aircraft 120a may move along a flight track opposite to that of the aircraft 120b. For example, when the aircraft 120a detects that the aircraft 120b will move towards the right direction, then the aircraft 120a move towards the left direction, so as to increase the distance D1 between the aircraft 120a and the aircraft 120b and avoid the collision with the aircraft 120b.

Furthermore, an anti-collision method in which an anti-collision module 244 is applied to determine the distance between the aircraft 120a and the aircraft 120b is disclosed in the following embodiments of the present invention. In this embodiment, the anti-collision module 244 includes multiple camera devices, at least one ultrasonic transceiver module and at least one virtual reality module. However, it should be understood by those of ordinary skills in the art that the present invention is not limited to the method adopted by the following embodiments, and various modifications and changes can be made without departing from the spirit and scope of the present invention.

In an embodiment, the aircraft 120a has multiple camera devices which shoot the aircraft 120b to take multiple image pictures, and calculate the distance D1 between the aircraft 120a and the aircraft 120b at a certain time according to the image pictures, wherein when the distance D1 is smaller than a threshold value, the anti-collision module 244 determines that a collision will occur between the aircraft 120a and the aircraft 120b. Furthermore, through such a method, whether the substance in the image picture is an aircraft or a bird is further identified, so as to avoid an erroneous determination.

In another embodiment, the aircraft 120a has at least one ultrasonic transceiver module, such that the aircraft 120a emits a ultrasonic wave (in general, the transmission distance of the ultrasonic wave is about 20 centimeters to 7 meters), and when the ultrasonic wave touches the aircraft 120b, a reflected wave is generated; and the aircraft 120a receives the reflected wave and calculates the distance D1 (e.g., 90 centimeters) between the aircraft 120a and the aircraft 120b at a specific time according to the time difference between the receipt of the reflected wave and the emit of the ultrasonic wave, wherein when the distance D1 is smaller than a threshold value (e.g., 1 meters), the anti-collision module 244 determines that a collision will occur between the aircraft 120a and the aircraft 120b.

Also for example, as shown in FIG. 5, after the ultrasonic wave is emitted by the aircraft 120a and the ultrasonic wave touches the aircraft 120b and the aircraft 120c, a first reflected wave and a second reflected wave are respectively generated. The aircraft 120a receives the first reflected wave and the second reflected wave, wherein if the aircraft 120a receives the first reflected wave earlier than the second reflected wave, then it can be seen that the aircraft 120b is closer to the aircraft 120a while the aircraft 120c is farther to the aircraft 120a. Also the distance D1 (e.g., 80 centimeters) between the aircraft 120a and the aircraft 120b at a specific time is calculated according to the time difference between the receipt of the first reflected wave and the emit of the ultrasonic wave, and the distance D2 (e.g., 30 centimeters) between the aircraft 120a and the aircraft 120c at a specific time is calculated according to the time difference between the receipt of the second reflected wave and the emit of the ultrasonic wave. On the other hand, since the distance between the aircrafts 120d-120f and the aircraft 120a is larger, e.g., the distance between the aircraft 120d and the aircraft 120a being 40 meters. If a distance (e.g. 40 meters) exceeds the maximum touchable range of the ultrasonic wave, the ultrasonic wave emitted by the aircraft 120a cannot touch the aircraft 120d and even cannot touch the farther aircrafts 120e-120f. Therefore, the aircraft 120a does not receive any reflected wave from the aircrafts 120d-120f.

In another embodiment, the aircraft 120a has at least one virtual reality module which enables the aircraft 120a to emit an infrared light. When the infrared light touches the aircraft 120b, a reflected infrared light is generated. The aircraft 120a receives the infrared reflected light and determines the coordinate position of the aircraft 120b according to the luminance of the reflected infrared light, so as to calculate the distance D1 between the aircraft 120a and the aircraft 120b at a specific time, wherein when the distance D1 is smaller than a threshold value, the anti-collision module 244 determines that a collision will occur between the aircraft 120a and the aircraft 120b.

As such, if the anti-collision module 244 determines that a collision will occur between the aircraft 120a and the aircraft 120b, the aircraft 120a can automatically adjust the flying state of itself, such that an appropriate safe distance is kept between the aircraft 120a and other aircrafts. Furthermore, since each of the aircrafts 120a-120n uses a corresponding anti-collision modules 244 to determine whether a collision will occur between the aircraft and other aircrafts, the calculation burden is shared, and the problem of too late to calculate caused by transmitting all flight information back to the aircraft controller 110 on the ground is avoided.

Through the aforementioned technical solution, the flying manner of multiple aircraft formations can be controlled, and meanwhile the effect presenting device is driven to form a whole formation audio-visual effect. Furthermore, in the present invention the flying formation of the aircrafts is presented according to the settings of the flight script, and various audio-visual effects of these aircrafts are presented in the air. Additionally these aircrafts have the characteristic of being reusable, such that the environmental pollution is reduced and the cost is decreased.

What is claimed is:

1. An aircraft three-dimensional exhibition system, comprising:
an aircraft controller;
a plurality of aircrafts, each comprising:
an effect presenting device for providing an audio-visual effect;
a communication device for receiving a flight control signal from the aircraft controller; and
an effect arrangement device for providing a flight script which comprises a formation information and a flight track of the aircrafts in the flight period;
wherein the aircrafts fly in formation according to the flight script to form a whole formation audio-visual effect by the audio-visual effects provided by each of the aircrafts.

2. The aircraft three-dimensional exhibition system of claim 1, wherein the aircraft controller comprises:
a dynamic reaction device for controlling the aircraft to fly along the flight track according to the flight control signal;
a remote control device connected in communication with the communication devices of the aircrafts, wherein remote control device sends the flight control signals to the aircrafts according to the flight script, such that the aircrafts fly in formation according to the content of the flight script and meanwhile the audio-visual effect is provided.

3. The aircraft three-dimensional exhibition system of claim 1, wherein each of the aircrafts further comprises:
an anti-collision module for calculating a relative distance between the aircraft and an another aircraft, so as to determine whether a collision will occur between the aircraft and the another aircraft.

4. The aircraft three-dimensional exhibition system of claim 3, wherein:
a plurality of camera devices of the anti-collision module shoot the another aircraft to take a plurality of image pictures; and the anti-collision module calculates a distance between the aircraft and the another aircraft at a specific time according to the picture images, wherein when the distance is smaller than a threshold value, the anti-collision module determines that a collision will occur between the aircraft and the another aircraft.

5. The aircraft three-dimensional exhibition system of claim 3, wherein:
the anti-collision module emits an ultrasonic wave, and generates a reflected wave after the ultrasonic wave touches the another aircraft;
the anti-collision module receives the reflected wave, and calculates a distance between the aircraft and the another aircraft at a specific time according to a time difference between the receipt of the reflected wave and the emit of the ultrasonic wave, wherein when the distance is smaller than a threshold value, the anti-collision module determines a collision will occur between the aircraft and the another aircraft.

6. The aircraft three-dimensional exhibition system of claim 3, wherein:
the anti-collision module emits an infrared light, and a reflected infrared light is generated after the infrared light touches the another aircraft;
the anti-collision module receives the reflected infrared light, and determines the coordinate position of the another aircraft according to the luminance of the reflected infrared light, so as to calculate a distance between the aircraft and the another aircraft at a specific time, wherein when the distance is smaller than a threshold value, the anti-collision module determines that a collision will occur between the aircraft and the another aircraft.

7. The aircraft three-dimensional exhibition system of claim 1, wherein the effect presenting device is at least one of a light-emitting device, a firework emitting device, a drikold emitting device or a smoke emitting device.

8. The aircraft three-dimensional exhibition system of claim 1, wherein these aircrafts are unmanned aircrafts.

9. An aircraft three-dimensional exhibition controlling method for controlling a plurality of aircrafts, wherein each of the aircrafts comprises an effect presenting device, and the aircraft three-dimensional exhibition controlling method comprises:
establishing a flight script comprising a formation information and a flight track of the aircrafts in a flight period;
generating a plurality of flight control signals according to the flight script, and sending the flight control signals respectively to the aircrafts; and
controlling the aircrafts to fly in formation, and meanwhile driving the effect presenting devices to form a whole formation audio-visual effect.

10. The aircraft three-dimensional exhibition controlling method of claim 9, wherein the step of controlling the aircrafts to fly in formation further comprises:
monitoring a relative distance between an aircraft and an another aircraft in real time; and
adjusting a flying state of the aircraft when a distance between the aircraft and the another aircraft at a specific time is smaller than a threshold value.
